(19) United States
(12) Patent Application Publication
(10) Pub. No.: US 2002/0060663 A1
(43) Pub. Date: May 23, 2002

(54) Computer input device for multiple-dimensional control

(76) Inventor: Yanqing Wang, Maple Ridge (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/042,326

(22) Filed: Jan. 11, 2002

Related U.S. Application Data
(63) Continuation of application No. PCT/CA00/00878, filed on Jul. 28, 2000.
(60) Provisional application No. 60/146,124, filed on Jul. 30, 1999.

(51) Int. Cl. G09G 5/00

(52) U.S. Cl. 345/156

(57) ABSTRACT

A computer input device (100) has both a 2-D position sensor (104, 146, 148) and a 1-D control (112, 150) mounted on a housing (102). The 2-D position sensor generates signals in response to movement of the input device across a surface (S). A user can select between a mode in which the 2-D position sensor generates signals responsive to movements of the housing relative to the surface and the 1-D control is insensitive to movements of the housing relative to the surface and, a mode in which the 1-D control generates signals responsive to movements of the housing relative to the surface. In preferred embodiments switching between the modes involves tilting the housing. The 1-D control preferably has an exposed portion (126) which permits it to be manipulated by a finger. The 1-D control may include a rotatable ring (112), which has a lower portion (124) capable of being frictionally engaged with an underlying surface. In various embodiments the rotatable member may be a ball (222), drum (190), or wheel (198).

### CROSS REFERENCE TO RELATED APPLICATIONS

This application is a continuation of International application No. PCT/CA00/00878, filed on Jul. 28, 2000, which designates the United States. This application claims the benefit of the filing date of U.S. patent application No. 60/146,124 filed Jul. 30, 1999 and entitled COMPUTER INPUT DEVICE FOR MULTIPLE-DIMENSIONAL CONTROL. The subject matter of this invention is related to the subject matter of U.S. Pat. No. 5,936,612 entitled COMPUTER INPUT DEVICE AND METHOD FOR 3-D DIRECT MANIPULATION OF GRAPHIC OBJECTS which issued on Aug. 10, 1999.

### TECHNICAL FIELD

This invention relates to computer input devices. The invention may be embodied in a computer mouse. The invention has particular application to providing input devices which can provide three-dimensional (3-D) direct manipulation of graphic objects for human-computer interaction.

### BACKGROUND OF THE INVENTION

There are numerous instances wherein a computer user is called upon to manipulate data in three or more dimensions. For example, a computer program which models an object in space may permit a user to move the object relative to x, y and z axes. The program may also permit the user to rotate the object in a virtual space. In general, controlling the position of a three dimensional object in space requires control over three or more independent dimensions.

Modern human computer interfaces allow a user to directly “manipulate” graphic objects to control the operation of a host computer system. For example, motion of a cursor on a computer display may be guided by an input device operated by a user. The amount of motion of the input device in various directions is measured. The cursor is moved by corresponding amounts in corresponding directions. A user may use the cursor to select items from a menu or press graphical “buttons” displayed on the computer display. The effectiveness and efficiency of direct manipulation depends on providing computer input devices which allow a user to intuitively interact with the graphical objects displayed by the computer system.

Typical direct manipulation devices, including mice, trackballs, joysticks and light pens, provide a spatial compatibility between motor control of a human hand and the resulting movements of graphical objects displayed on a computer display. Mice, in particular, have become standard direct manipulation devices for today's computers. A limitation of conventional computer mice and most other prior art input devices is that they produce only two-dimensional input. For example, in current applications, a mouse is usually used as a pointing device or cursor locator by mapping hand translation movements on a flat surface (having two degrees of freedom) onto two dimensional (“2-D”) translation movements of a cursor on a computer display.

Providing multi-dimensional control with conventional computer input devices is not always convenient or intuitive. For example, a typical computer mouse or track-ball provides two-dimensional control. A conventional mouse or trackball becomes awkward when one is trying to simultaneously control three or more dimensions.

There is a need to add a third dimension to direct manipulation devices for human-computer interaction. The third dimensional input “Z” can be combined with two-dimensional inputs “X” and “Y” to facilitate three dimensional (“3-D”) direct manipulation, such as 3-D pointing in virtual reality, simultaneous control of object translation and rotation in computer-aided design/computer aided manufacturing (“CAD/CAM”) drawings, or zooming while “walking” through a graphic scene. Providing a third dimensional input is also desirable because the third dimension can serve as an independent one-dimensional (“1-D”) control over some aspect of a computer operation. For example, an independent 1-D direct manipulation of graphic objects can be very useful for tasks such as scrolling a document, zooming in one direction, or surfing between web pages.

It is typically difficult and tedious to use a standard 2-D mouse for 3-D direct manipulation tasks. For a simultaneous 3-D manipulation task, users usually have to first mentally break the task into 1-D or 2-D components and then perform the task one component at a time. For example, in current drawing applications, in order to move a graphic object to a new position which requires the object to be both translated and rotated users must first translate the object to its desired location, shift to a different mode which permits rotation of the object, and then rotate the object about a fixed point. Similarly, when performing 1-D manipulations, such as dragging a scroll box along a scroll bar, with current 2-D mice, users must guide the 2-D mouse carefully so that the cursor remains on the 1-D control.

The prior art includes two types of computer input devices which provide a third dimensional input. One such device is the “dual detector mouse”, which consists of two spaced apart 2-D translation detectors, such as roller balls. Each of the balls has a pair of orthogonal encoders which produce “X” and “Y” signals. One of the detectors serves as a primary detector. The primary detector senses 2-D translation movements of the mouse over a surface and provides primary X and Y inputs to a host computer system. X and Y inputs from the second detector can be combined with the primary inputs from the primary detector and used to calculate an angle of rotation of the mouse relative to the surface. This angle of rotation can be used as a third dimensional or “Z” input. A dual detector mouse is described, for example, in U.S. Pat. No. 5,512,920.

One major disadvantage of the dual detector mouse is that it is difficult to provide independent 1-D manipulation of a graphic object. The “Z” input is not independent of translations in the other two dimensions. For example, while turning a graphic object around a fixed point, or zooming on a document, it is very hard for the user to rotate a dual detector mouse without translating it at the same time. In addition, the rotation center of the dual detector mouse must be arbitrarily pre-determined, and the algorithms for calculating rotation angles are not straightforward to the user.

Another type of computer input devices which can produce a third dimensional input is the “wheel mouse”. U.S. Pat. No. 5,473,344 describes a wheel mouse. A wheel mouse operates in substantially the same way as a conventional mouse but has a small wheel or roller projecting from its top surface. The wheel can be turned by a user's thumb or other fingers to provide a third dimensional input. Unlike the dual detector mouse, the wheel mouse allows an independent 1-D direct manipulation for tasks such as one-dimensional zooming and scrolling. The wheel is convenient for making small movements but is awkward to use for large movements, such as scrolling through many pages of a long document. It is also hard to use a wheel mouse to achieve a simultaneous 3-D direct manipulation. For example, to move a graphic object to a location with a specific orientation in CAD/CAM drawings, the user may have to first translate the mouse to cause an object to move to the required location and then rotate the wheel to turn the object to the desired orientation. This procedure is similar to using a current 2-D mouse for the same task and is cumbersome. Further, users may need to exercise careful motor control to coordinate manipulation of the wheel with a finger and movement of the mouse by hand.

Computer software applications may require switching among 1-D, 2-D and 3-D control modes from time to time. For example, in CAD/CAM drawing applications, a user may want to simultaneously translate and rotate a graphic object to match a target location and orientation (3-D manipulation), then zoom in to see details of the graphic object (1-D manipulation), and then make a final adjustment of the object's position by translating the object (2-D manipulation). When surfing on the Internet, a user may want to provide a 1-D input (“Z”) for scrolling on web page, a 2-D input (X and Y) for locating a hot link on the displayed portion of a selected web page, and a 3-D input (X, Y and Z together) for simultaneously scrolling the page and locating the hot link. A smooth change of control modes is necessary so as not to interrupt the user's focus on the task.

There is an increasing need for computer input devices which are intuitive to use and which permit users to directly control in more dimensions than the two dimensions offered by a standard mouse. There is a particular need for a computer input device which can provide 1-D, 2-D and 3-D direct manipulation of graphic objects and can be switched easily between 1-D, 2-D and 3-D modes.

### SUMMARY OF THE INVENTION

This invention provides computer input devices which have 2-D position sensors such as roller balls or optical sensors in combination with a 1-D control. The 1-D control can be adjusted by moving a housing relative to an underlying surface. In preferred embodiments of the invention the 1-D control includes a rotatable member having an exposed portion located so that a user can rotate the member with a finger. In this document the word “finger” includes thumbs. In preferred embodiments of the invention a lower portion of the member can be selectively engaged, so that the 1-D control generates a signal as the input device is moved across a surface or disengaged.

Accordingly, one aspect of the invention provides a computer input device comprising: a) a hand holdable housing; a 2-D position sensor on the housing for monitoring movements of the housing relative to a surface under the housing; and, a 1-D position sensor on the housing for monitoring movements of the housing relative to a surface under the housing. When the housing is on an underlying surface in a first orientation, the 2-D position sensor generates signals responsive to movements of the housing relative to the surface and the 1-D position sensor is insensitive to movements of the housing relative to the surface. When the housing is on an underlying surface in a second orientation, the 1-D position sensor generates signals responsive to movements of the housing relative to the surface. Preferably the first orientation has the housing sitting flat on an underlying surface. The second orientation has the housing tilted with respect to the underlying surface. In preferred embodiments a lower surface of the housing comprises a portion which projects past the 1-D position sensor and supports the 1-D position sensor spaced apart from the surface when the housing is in its first orientation. The projecting portion may be a central portion of a lower surface of the housing. The 1-D position sensor preferably comprises a rotatable element rotatably mounted on the housing.

Another aspect of the invention provides a computer input device comprising: a hand holdable housing; a 2-D position sensor on the housing for monitoring movements of the housing relative to a surface under the housing; and, a 1-D control on the housing. The 1-D control comprises a member rotatable about a single axis and an encoder associated with the rotatable member. The encoder generates a signal indicating rotation of the rotatable member about the single axis. The rotatable member is frictionally engageable with a surface underlying the housing and is rotatable by moving the housing across an underlying surface when the rotatable member is frictionally engaged with the underlying surface. Examples of rotatable members are wheels, rings, and the like.

Another aspect of the invention provides a computer input device comprising a hand-holdable housing; a 2-D position sensor on the housing for monitoring movements of the housing relative to a surface under the housing; and, a 1-D control on the housing. The 1-D control comprises a rotatable member. The rotatable member has a first exposed part manipulable by a user's finger or thumb and a second exposed portion on an underside of the housing. The second exposed portion is frictionally engageable with a surface under the housing and is rotatable by moving the housing across an underlying surface when the rotatable member is frictionally engaged with the underlying surface.

One specific aspect of the invention provides a computer input device comprising: a hand holdable housing having a lower surface, the housing configured to sit upright on a surface under the housing; a member rotatably mounted to the housing for rotation about an axis of rotation, the rotatable member having a surface-contacting portion exposed on the lower surface of the housing, the surface-contacting portion lying in a plane generally perpendicular to the axis, the surface contacting portion oriented in the housing such that, when the housing is sitting upright on a surface, the plane of the surface-contacting portion is parallel to the surface, the rotatable member located so as to be rotatable about the axis by frictional contact between the surface-contacting portion and a surface under the housing; an encoder in the housing for sensing rotary motion about the axis of the rotatable member relative to the housing; and, means for transferring rotation information from the encoder to a host computer system.

Other features and advantages of the invention are described below.

### BRIEF DESCRIPTION OF THE DRAWINGS

The accompanying drawings illustrate non-limiting embodiments of the invention. The drawings are schematic in nature, various details of construction not essential to understanding the invention have been omitted. In the drawings, FIGS. 1A through 7B illustrate input devices of a first type which include a combination of a 2D position sensor and a 1D position sensor. In the embodiments of the invention illustrated in these drawings the 1D position sensor comprises a ring which is exposed on a lower face of the device and the 2D position sensor comprises a rotatable ball.

In FIGS. 1A through 7B:

FIG. 1A shows a top isometric view of mouse according to the invention having a 2D rotating-ball position sensor and a 1D rotatable ring;

FIG. 1B is a perspective view of the ring from the mouse of FIG. 1A;

FIG. 1C is a bottom isometric view of the mouse of FIG. 1A;

FIG. 2A is a side elevation through the mouse of FIG. 1A;

FIGS. 2B, 2C and 2D are sectional views through the mouse of FIG. 1A in which, FIG. 2A shows the mouse positioned to provide 2D control using the rotatable ball only, FIG. 2B shows the mouse positioned to provide 3D control using both the rotatable ball and the ring, and FIG. 2C shows the mouse positioned to provide 1D control using only the ring as an input;

FIG. 3 is a bottom view illustrating a possible arrangement of encoders in the mouse of FIG. 1A;

FIG. 4A shows a cross sectional view of a mouse according to an alternative embodiment of the invention wherein the mouse must be tilted to bring the ring into contact with a surface under the mouse;

FIG. 4B is a cross sectional view of the mouse of FIG. 4A in a tilted position so that its ring can be turned by moving the mouse relative to an underlying surface;

FIGS. 5A and 5B are respectively a perspective view of a disassembled adjustable-height ring and a section through a mouse according to the invention which is equipped with the adjustable-height ring of FIG. 5;

FIG. 6A is a bottom isometric view of a mouse according to the invention having a vertically floating ring;

FIG. 6B is an elevational section through the mouse of FIG. 6A;

FIG. 7A is a bottom isometric view of a mouse according to the invention equipped with a cylindrical ring; and, FIG. 7B is an isometric view of the ring from the mouse of FIG. 7A.

FIGS. 8A, 8B and 8C are respectively a bottom isometric view; a front end elevational view and a section through a mouse according to the invention equipped with an inclined ring.

FIGS. 9A through 16B relate to embodiments wherein the 1D sensor and 2D sensor are located beside one another. In FIGS. 9A through 16B:

FIG. 9A is a bottom isometric view of a mouse having a rotatable drumshaped 1-D sensor located beside a 2D rolling-ball sensor;

FIG. 9B is an isometric view of the 1D sensor of the mouse of FIG. 9A;

FIG. 9C is a front end elevational view of the mouse of FIG. 9A;

FIGS. 10A and 10B are respectively a top plan view and an end elevational view of a mouse having a rotatable drum type 1D sensor mounted adjacent a rolling ball type 2D sensor;

FIGS. 11A and 11B are respectively a top plan view and a side elevational view of a mouse having a rotatable wheel;

FIG. 11C is a detail of the rotatable wheel of the mouse of FIGS. 11A and 11B;

FIG. 12 is a side elevational view of a mouse having a transversely mounted rotatable wheel;

FIGS. 13A and 13B are respectively a top plan view and an end elevational view of a mouse having a rotatable wheel according to another embodiment of the invention;

FIGS. 14A and 14B are respectively a top plan view and a side elevational view of a mouse having two rotatable ball sensors which may be used independently;

FIGS. 15A and 15B are respectively a top plan view and an end elevational view of a mouse according to a further embodiment of the invention which has two rotatable ball sensors which may be used independently; and, FIGS. 16A and 16B are respectively a top plan view and an end elevational view of a mouse according to a still further embodiment of the invention which has two rotatable ball sensors which may be used independently.

FIG. 17 is a section through a mouse according to the invention which is similar to the mouse of FIG. 1A but has an optical sensor in place of the rotating ball sensor of the mouse of FIG. 1.

### DETAILED DESCRIPTION

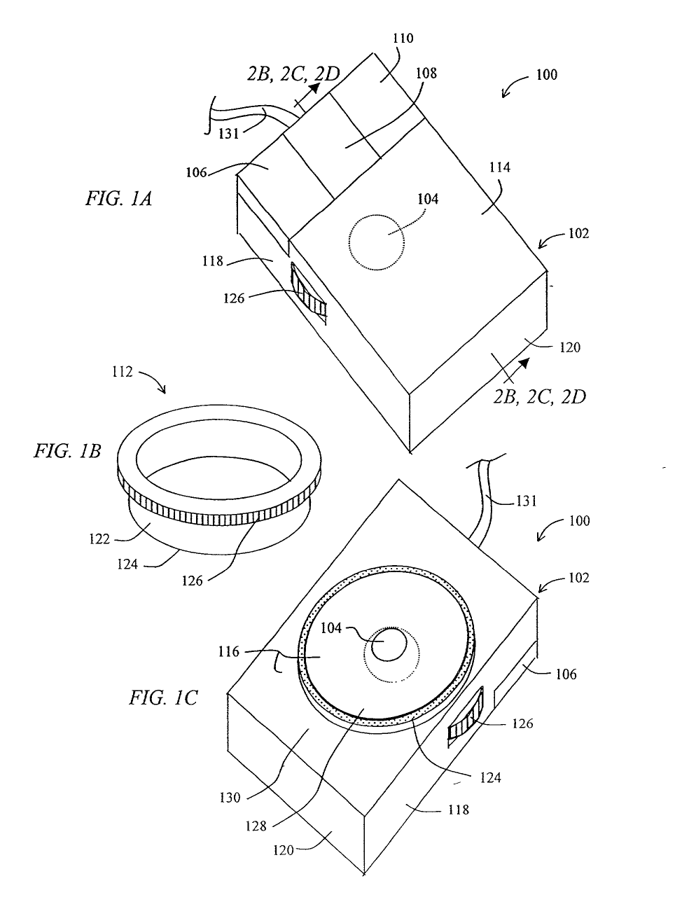

FIGS. 1A, 1B and 1C, show a mouse 100 according to a preferred embodiment of the invention. Mouse 100 has a housing 102. A ball 104 is rotatably mounted in housing 102. The lower surface of the housing has an opening through which ball 104 is exposed. As a user slides housing 102 across a surface S under the housing, ball 104 rolls across the surface. Ball 104 and its associated encoders constitute a 2-D position sensor. The rotation of ball 104 can be measured to obtain two dimensional movement information as in a conventional computer mouse. Housing 102 has a top side 114, a bottom side 116, a left side, 118 and a rear side 120. A left button 106, a middle button 108, and a right button 110 are located on top side 114. A user can operate these buttons to send control signals to a computer. Such buttons are known and are common on computer mice. A cord 131 connects mouse 100 to a host computer.

Unlike a conventional computer mouse, mouse 100 has a ring 112 which is mounted for rotation in housing 102. Ring 112 has a generally cylindrical main body 122 having a bottom portion 124. A flange 126 extends laterally from main body 122. Flange 126 and main body 122 are preferably integral with one another. The outside surface of flange 126 and bottom portion 124 are preferably coated with high friction materials such as rubber. Ring 112 and its associated encoder constitute a 1-D control.

As shown in FIG. 1A, flange 126 projects through housing 102 so that a user can turn ring 112 relative to housing 102 by pushing on the exposed portion of flange 126 with a finger or thumb. In the illustrated embodiment, a portion of flange 126 projects through an aperture on left side 118 of housing 102. If a user grasps housing 102 with the user's right hand then the user can readily rotate ring 112 in either direction by pushing the exposed portion of flange 126 either forward or rearward with his or her right thumb. The user can do this without significantly changing his or her grip on housing 102.

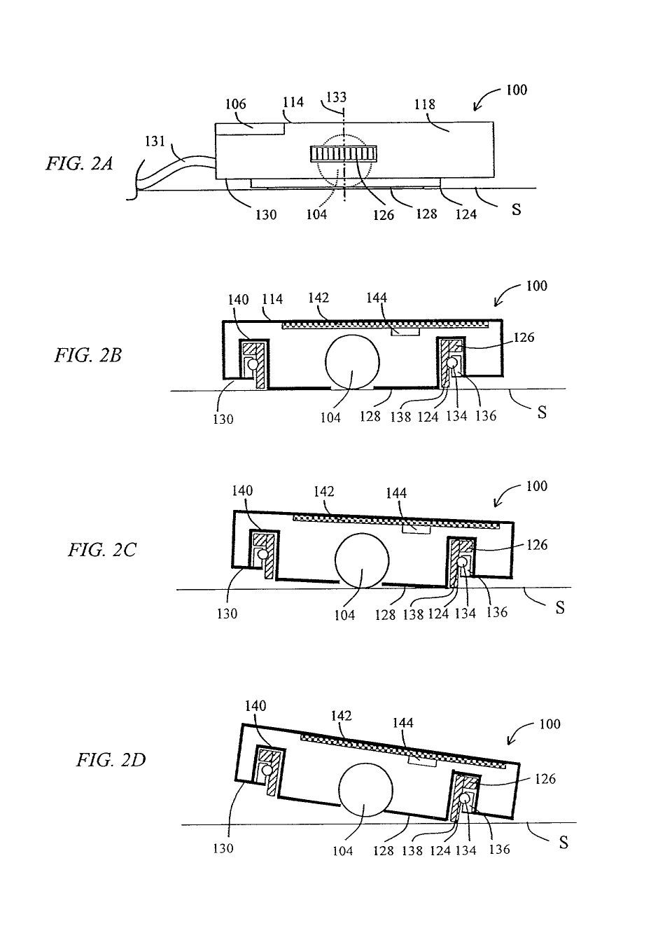

As shown in FIG. 1C, bottom portion 124 of ring 112 is exposed on bottom side 116 of housing 102. Bottom side 116 of housing 102 is divided into an inner surface 128 inside the exposed circular bottom portion 124 of ring 112 and an outer surface 130 which is outside bottom portion 124. Ball 104 protrudes through an aperture within ring 112. Preferably, as illustrated in FIG. 2A, a center of ball 104 lies on the axis of rotation 133 of ring 112.

As shown in FIGS. 2A, 2B, 2C and 2D, a user can cause ring 112 to rotate by moving housing 102 across an underlying surface S while exposed bottom portion 124 is frictionally engaged with the surface S. The orientation of housing 102 and its direction of motion on the surface S determines the direction of rotation of ring 112. By selecting the orientation of housing 102 a user can also select between:

causing ball 104 to roll across surface S without rotating ring 112;

causing ring 112 to rotate without rotating ball 104;

causing ball 104 to roll and simultaneously rotating ring 112 as the housing 102 is moved across surface S.

As shown in FIG. 2B, when mouse 100 sits upright on a substantially flat surface S, inner surface 128 supports housing 102 on surface S. Ball 104 is in contact with flat surface S. Bottom portion 124 of ring 112 is supported slightly above surface S. When mouse 100 is in the orientation of FIG. 2B, it can be used as a regular mouse by sliding it in two dimensions over surface S (with the enhancement that a user can rotate ring 112 by manipulating flange 126 as described above). Backward compatibility with the functions of a regular mouse is desirable since two-dimensional control is common in computer applications. Mouse 100 can provide users with a similar feeling to the conventional mouse for two-dimensional control

Outer surface 130 is elevated from bottom portion 124 so that the laterally outward edges of bottom portion 124 are exposed under outer surface 130. A user can bring bottom portion 124 into contact with surface S by tilting mouse 100 relative to surface S as shown in FIG. 2C. The configuration of housing 102, ring 112 and ball 104 is such that ball 104 and bottom portion 124 can be simultaneously in contact with surface S. Typically ball 104 can drop slightly in housing 102 so that it can remain in contact with surface S even when housing 102 is tilted as shown. When a user holds housing 102 as shown in FIG. 2C then the user can simultaneously turn ring 112 and roll ball 104 by moving housing 102 across surface S.

As shown in FIG. 2D, mouse 100 can be tilted further so that bottom portion 124 remains in contact with surface S but ball 104 is lifted away from surface S. A user can rotate ring 112 without rotating ball 104 by placing mouse 100 in the orientation of FIG. 2D and moving mouse 100 across surface S. Preferably, housing 102 and ring 112 are so configured that mouse 100 can be tilted in any direction to bring bottom end 124 of ring 112 into contact with surface S.

As shown in FIGS. 2B, 2C and 2D, ring 112 is rotatably mounted within housing 102 with a bearing mechanism. In the illustrated embodiment the bearing mechanism comprises a number of bearing balls 134 which are rotatably embedded in blocks 136 which are fixed to housing 102. Bearing balls 134 run in a groove which extends circumferentially around ring 112. Housing 102 has bridge portions 140 which extend over ring 112 and connect inner surface 128 to outer surface 130. A printed circuit board (PCB) 142 in housing 102 carries electronic circuits 144 for transferring signals from mouse 100 to a host computer.

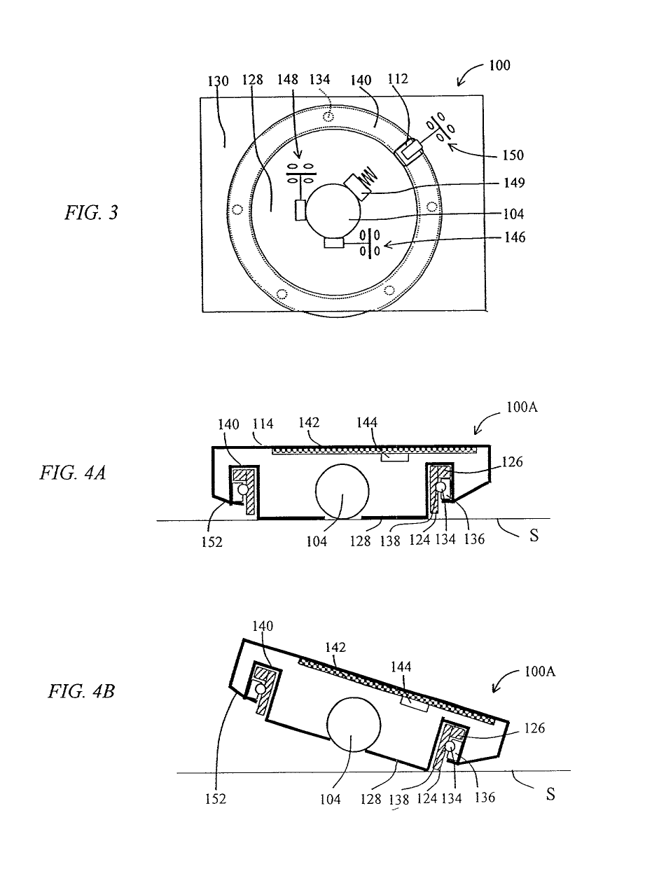

Suitable encoders for detecting rotation of a ball or the like and circuits for transmitting information about that rotation to a host computer are well known. FIG. 3 shows schematically a possible arrangement of encoders in mouse 100 for measuring rotation of ball 104 in two dimensions and for measuring rotation of ring 112 about is axis of rotation. Mouse 100, has an encoder 146 which senses the motion of ball 104 in an “X” direction and an encoder 148 which senses the motion of ball 104 in a “Y” direction. Encoders 146 and 148 are preferably orthogonally arranged. Each of encoders 146 and 148 has a roller which frictionally contacts ball 104. A spring-loaded roller 149 urges ball 104 against the rollers of encoders 146 and 148. Spring-loaded roller 149 allows encoders 146 and 148 to sense the motion of ball 104 even if ball 104 moves somewhat vertically relative to housing 102 as it rolls along surface S and as a user tilts housing 102 into the position of FIG. 2C.

An encoder 150 senses the rotation of ring 112. Encoder 150 may, for example, have a roller which projects through an aperture in bridge 140 and frictionally contacts ring 112. Preferably, encoder 150 is spring-loaded so that its roller is urged against ring 112.

The description of encoders 146, 148 and 150 is included here only as an example of a possible construction. Other types of encoders for measuring the rotation of an object, such as ball 104 or ring 112 are well known. In this description the term “encoder” is meant broadly to encompass any technology suitable for deriving 2D control signals from the rotation of ball 104 and for deriving 1D control signals from the rotation of ring 112.

Encoders 146 and 148 send two-dimensional signals to a host computer via electronic circuits 144. Encoder 150 sends one-dimensional signals to the host computer via circuits 144. Together, encoders 146, 148 and 150 provide three-dimensional input control for various computer tasks.

Signals from encoder 150 about the rotation of ring 112 are especially useful for one-dimensional control tasks such as zooming and scrolling within a document. As described above, mouse 100 provides the user with a choice to rotate ring 112 with either the thumb or the hand. For example, the user can hold mouse 100 upright and rotate rim 126 with the thumb for a fine zooming or scrolling. For tasks such as long document scrolling, the user can tilt mouse 100 to engage bottom portion 124 of ring 112 with flat surface S, and then use hand movements to rotate ring 112 to achieve fast scrolling. The user can also switch back and forth between using his or her thumb to control ring 112 and using whole hand motions to control ring 112 to avoid fatigue which could result from prolonged use of either the thumb or the hand.

Mouse 100 can be used as described above with reference to FIG. 2C to provide simultaneous three-dimensional control to a computer process. Three-dimensional input is especially useful for computer applications such as virtual reality. For example, a user might use mouse 100 in conjunction with appropriate software for graphic object translation in X, Y, and Z dimensions. In a different mode, mouse 100 could be used to control rotation of a graphic object about three different axes. Switching between different modes might be accomplished, for example, by holding down middle mouse button 108.

Mouse 100 allows a user easily to switch among one-, two- and three-dimensional control modes for various tasks. With mouse 100, the user does not have to search for a dedicated button on a mouse or an icon on a display for control mode changes. The user can focus on the task and simply tilt mouse 100 to switch between 1D, 2D and 3D control modes.

An input device such as mouse 100, provides a number of advantages over conventional 2-D pointing devices. Having a ring (or, as is the case in some of the alternative embodiments described below, another 1D sensor such as a second ball or the like) which can generate an independent 1D control signal allows a user to give a host computer information which may be used as a third dimensional or “Z” input. The input device provides X and Y translation and Z rotation signals which can be used for 3-D direct manipulation of graphic objects. A user can achieve a simultaneous 3-D control of graphic objects on a computer display by moving a mouse 100 over a flat surface S to simultaneously translate the mouse and to cause ring 112 to rotate. The rotation of ring 112 may be caused by either or both turning housing 102 of mouse 100 relative to surface S and applying pressure to one side or the other of housing 102 as mouse 100 is translated. Furthermore, the present invention allows the users to accelerate or stabilize the rotation process. A user can switch intuitively and simply between modes in which mouse 100 generates and transfers to a host computer system 1-D, 2-D or 3-D information.

FIGS. 4A and 4B show a mouse 100A according to an alternative embodiment of the invention. Mouse 100A differs from mouse 100 in that the bottom portion 124 of its ring 112 is elevated further from inner surface 128. The configuration of mouse 100A is such that bottom portion 124 of ring 112 can not be brought to contact with surface S until after ball 104 has been lifted away from surface S. A bevelled outer surface 152 allows mouse 100A to be tilted in any direction sufficiently to engage ring 112 with surface S. The embodiment of FIG. 4 allows a user to switch readily between 1D and 2D modes by tilting mouse 100A.

In a modified version (not shown) of the embodiment of FIGS. 4A and 4B, ring 112 could be made to project farther downward relative to inner surface 128 than is shown in FIGS. 4A and 4B. For example, bottom portion 124 could be even with the level of inner surface 128 or could even be slightly below the level of inner surface 128. When bottom portion 124 and inner surface 128 are at the same level, they together form the bottom contact surface for mouse 100A sitting upright on flat surface S. When bottom portion 124 projects downwardly past inner surface 128, bottom portion 124 supports mouse 100A on surface S. In either case, the modified version of mouse 100A could be used in 1D, 2D and 3D modes as described above in relation to FIGS. 2A, 2B and 2C.

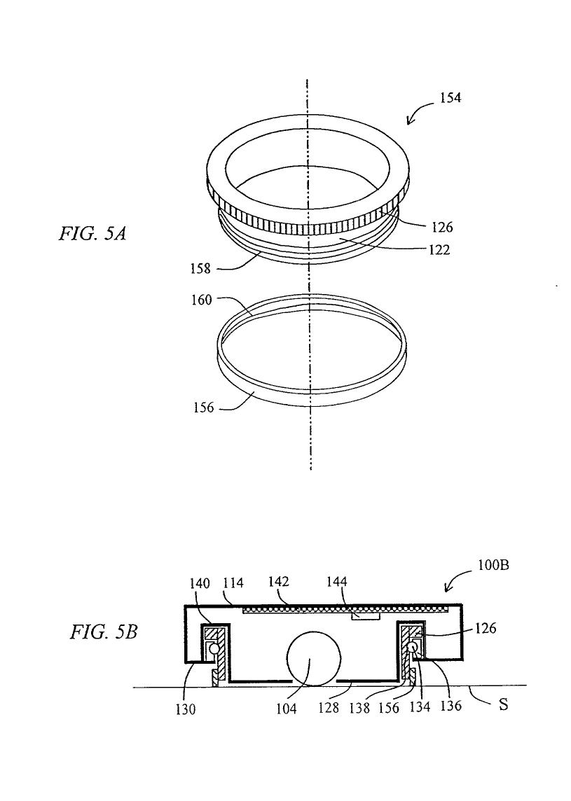

FIGS. 5A and 5B show a mouse 100B according to an alternative embodiment of the invention for which the position of bottom portion 124 relative to inner surface 128 is adjustable. Mouse 100B has a ring 154 which includes a main body 122 having a flange 126 and separate ring-shaped foot 156. Foot 156 has internal threads 160 which engage external threads 158 on the lower end of body 122. The overall height of ring 154 can be adjusted by screwing foot 156 on to or off of main body 122. Preferably, the position of foot 156 can be adjusted through a range sufficient to include positions such that the bottom of foot 156 is higher than the bottom of main body 122 as well as positions wherein the bottom of foot 156 projects below inner bottom surface 128. The user can adjust the height of ring 154 by holding flange 126 which protrudes from left side 118 of housing 102 with a finger and turning foot 156 accordingly. Foot 156 and main body 122 are attached to one another in a manner that is tight enough that there is no relative motion between them during normal use of mouse 100B when ring 154 is rotated by frictionally engaging flat surface 132. Those skilled in the art will realize that there are many other constructions that could be adopted for adjusting the position of a lower, surface engaging portion of a ring relative to a lower surface of a mouse housing. For example:

A foot similar to foot 156 could snap onto a main body 122 and have detents that allow it to be positioned at various extensions on main body 122.

The entire ring could be adjustable up and down in housing 102.

Inner surface 128 could be movable upwardly and downwardly relative to the ring and the rest of housing 102.

The ring could be supported in housing 102 by flange 126 and flange 126 could be made movable longitudinally along a cylindrical main body 122 (For example by providing external threads on the cylindrical main body and internal threads on a part comprising the flange ).

Support pads of various thicknesses could be attached to the bottom of mouse 100B.

In FIG. 5B, foot 156 is extended downwards so that mouse 100B is supported on foot 156 while inner surface 128 is spaced apart from surface S. Foot 156 can also be screwed upwards on main body 122 until mouse 100B is supported on surface S by inner surface 128 while foot 156 is either sitting on or spaced apart from surface S.

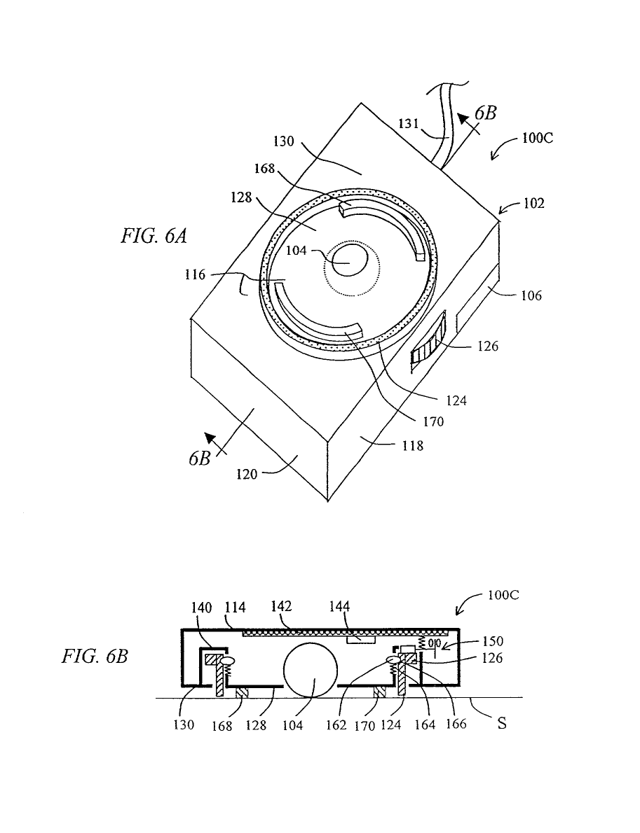

FIGS. 6A and 6B, show a mouse 100C according to another alternative embodiment of the invention in which a ring 112 is rotatably supported in housing 102 by a roller bearing 162. Bearing 162 permits ring 112 to rotate freely about a vertical axis. Bearing 162 is free to slide upward and downward in housing 102 and is biassed upwardly by springs 164.

Bottom portion 124 of ring 112 is projects downwardly from housing 102. Springs 164 support ring 112 with bottom portion 124 is spaced apart from surface S when mouse 100C sits upright on surface S. When mouse 100C is tilted to an angle, bottom portion 124 of ring 112 elastically engages surface S. Spring-loaded encoder 150 is biassed against ring 112 so as to constantly sense the rotation of ring 112 even when ring 112 moves vertically. An arc-shaped front foot 168 and rear foot 170 are affixed to inner surface 128. The bottoms of feet 168 and 170 form the bottom contact surface for mouse 100C sitting upright on surface S. Preferably, inner surface 128 and outer surface 130 have the same height and are parallel to the bottom contact surface formed by feet 168 and 170.

In the foregoing embodiments and in others described below, the 1-D sensor comprises a rotatable member located win a position which permits it to be frictionally engaged with an underlying surface S. Preferably the portion of the 1-D sensor which contacts surface S, whether it be a ring, wheel, or other rotatable member, is resiliently mounted. This may be accomplished in any suitable manner. For example: the rotatable member maybe coupled to housing 102 by a coupling which includes springs (one possible construction is shown schematically in FIG. 6B); the rotatable member may be weighted and mounted so that it can float vertically (a standard mouse is an example); or the rotatable member may include a resilient surface-contacting portion. This makes the input device more resistant to breakage and accommodates wear.

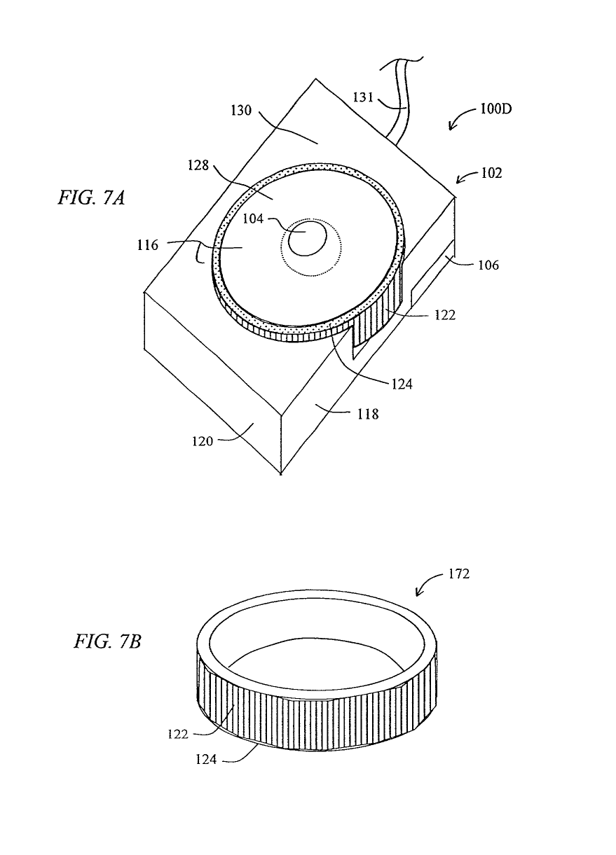

FIGS. 7A and 7B, show a mouse 100D according to a further alternative embodiment of the invention in which the ring has no flange portion. Mouse 100D has a cylinder-shaped ring 172 rotatably mounted in an annular track within a housing 102. Ring 172 has main body 122 and bottom portion 124. The annular track in which ring 172 rotates intersects side 118 of housing 102 so that a portion of main body 122 is exposed. A user can rotate ring 122 by sliding his or her thumb forward or rearward on the exposed surface of ring 172.

Bottom portion 124 of ring 172 projects downwardly from an aperture between inner surface 128 and outer surface 130. Ring 172 can also be rotated by tilting mouse 100D and moving mouse 100D with the hand while bottom portion 124 is frictionally engaged with a surface S. An encoder within housing 102 senses the rotation of ring 172 and sends 1D signals to a host computer as described above with respect to mouse 100 of FIGS. 1A through 3.

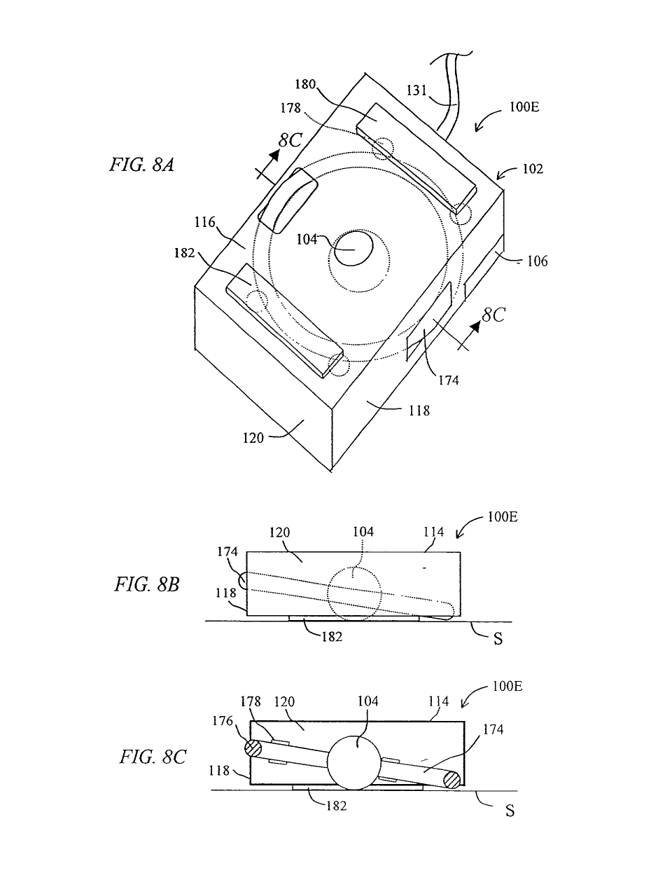

All of the mice described above have a rotatable ring structure which has a fully exposed bottom portion and a 2D sensor mounted on a bottom surface inside the ring. FIGS. 8A, 8B and 8C, show a mouse 100E according to another alternative embodiment of the invention in which the bottom portion of the ring is not fully exposed. Mouse 100E has a ring 174 which is rotatably mounted within a housing 102. Ring 174 is inclined toward the right hand side of mouse 100E and is mounted in suitable bearings 178 so that it is free to rotate about an axis which is perpendicular to the plane of ring 174. Feet 180 and 182 on bottom side 116 of housing 102 support mouse 100E.

A portion 174A of ring 174 is exposed on left side 118 of housing 102. A user can rotate ring 174 by engaging exposed portion 174A with his or her thumb, as described above. Another portion 174B of ring 174 protrudes downwardly from an aperture on bottom side 116 of housing 102. Portion 174B of ring 174 is spaced apart from surface S when mouse 100E us sitting upright on surface 132. A user can also rotate ring 174 by tilting mouse 100E to the right so that portion 174B frictionally contacts a surface S and then moving mouse 100E across the surface. An encoder senses the rotation of ring 174 and sends signals to a host computer.

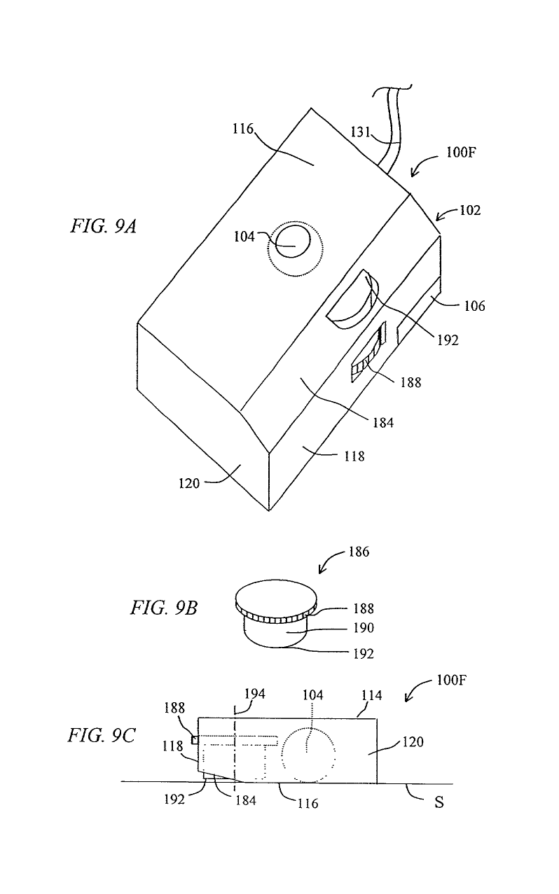

The invention may be applied to provide computer input devices which can be readily switched between 2D modes and 1D modes but do not necessarily provide simultaneous 3D control. The embodiments of FIGS. 9A through 12 are examples of this. FIGS. 9A, 9B and 9C, show a mouse 100F according to a further alternative embodiment of the invention. In this embodiment, the function of the ring is supplied by a drum-shaped roller 186 which is rotatably mounted within housing 102. Housing 102 has a bevelled surface 184 at the interface of its left side 118 and bottom side 116. Roller 186 has a flange portion 188, a main body 190 and a bottom portion 192. A portion 186A of flange portion 188 is exposed on left side 118. A portion 186B of bottom portion 192 is exposed and projects past bevelled surface 184. Bottom portion 192 is spaced apart from surface S when mouse 100F sits upright on surface 132. In this configuration mouse 100F functions as a conventional mouse.

Roller 186 is rotatable about a vertical axis 194. A user can cause roller 186 to turn about is axis 194 by sliding their thumb along left side 118 of housing 102 while engaging exposed portion 186A of roller 186. A user can also rotate roller 186 by tilting mouse 100F to the left until exposed portion 186B of lower portion 192 contacts and engages surface S. An encoder (not shown) within housing 102 senses the rotation of roller 186 and sends signals to a host computer.

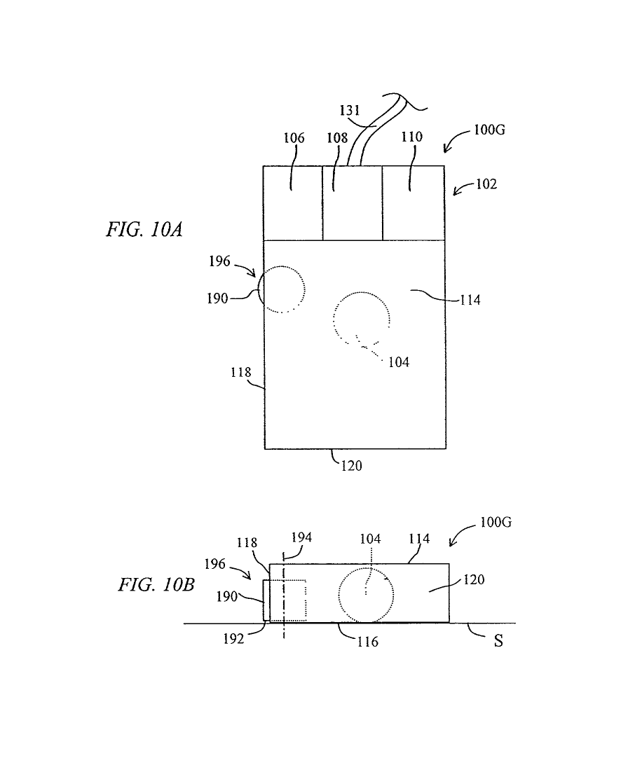

FIGS. 10A and 10B show a mouse 100G according to a variation of the embodiment of FIG. 9A. A generally cylindrical roller 196 which has a main body 190 and a bottom portion 192 is mounted in housing 102 for rotation about a generally vertical axis 194. A portion of roller 196 protrudes on left side 118 of housing 102. Bottom portion 192 is spaced apart from flat surface S when mouse 100G sits upright on the surface S.

A user can rotate roller 196 with his or her thumb, as described above. Additionally, the user can tilt housing 102 until the bottom portion 192 of roller 196 contacts surface S and rotate roller 196 by moving mouse 100G across the surface S. An encoder (not shown) within housing 102 senses the rotation of roller 196 and sends signals to a host computer.

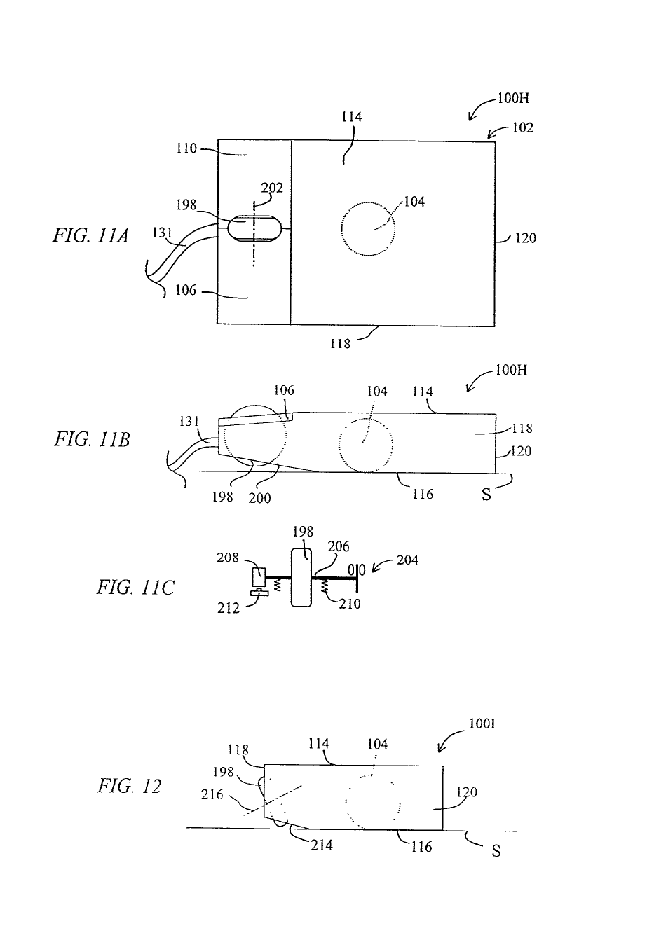

FIGS. 11A, 11B and 11C, show a mouse 100H according to another alternative embodiment. Mouse 100H has a rotatable wheel, similar to the wheel of a “wheel mouse” such as a Microsoft™ IntelliMouse™. The wheel of mouse 100H is exposed both on the upper and lower surfaces of mouse 100H. Wheel 198 is rotatably mounted to housing 102 so that it can turn about a generally horizontal transversely oriented axis 202. A portion 198A of wheel 198 protrudes downwardly past a front bevelled surface 200 of housing 102. A portion 198B of wheel 198 protrudes from an aperture between left button 106 and right button 110 on top side 114 of housing 102.

When mouse 100H is sitting normally on a surface S, wheel 198 is spaced apart from surface S. With mouse 100H in this position mouse 100H can be used as a conventional wheel mouse. Wheel 198 can be rotated by engaging exposed portion 198B with a finger. Unlike a conventional wheel mouse, wheel 198 can also be rotated by tilting mouse 100H to the front until portion 198B of wheel 198 engages surface S and moving mouse 100H along surface S. Thus wheel 198 can be used as a standard wheel mouse for fine positioning and can be rolled along a surface S for fast scrolling. An encoder 204 within housing 102 senses the rotation of wheel 198 and sends signals to a host computer.

In the embodiment illustrated in FIG. 11C,encoder 204 and wheel 198 are both mounted on a shaft 206. A roller 208 is also mounted on shaft 206. Wheel 198, shaft 206 and roller 208 all rotate together about axis 202. Shaft 206 is spring loaded with springs 210 so that wheel 198 and roller 208 together are vertically moveable. If wheel 198 is pressed downwardly, for example by a user's finger, roller 208 presses on a switch 212. Wheel 198 can therefore be clicked to serve as a mouse button for input control.

FIG. 12 shows a mouse 100I, is shown according to a further embodiment of the invention. Mouse 100I has an inclined wheel 198 rotatably mounted to housing 102. A portion 198A of wheel 198 is exposed on left side 118 of housing 102. A second portion 198B of wheel 198 protrudes downwardly from a left bevelled surface 214 of housing 102. When mouse 100I sits upright on a flat surface S wheel 198 is spaced apart from surface S. As in other embodiments described herein, a user can rotate wheel 198 about an axis 216 either by sliding their thumb along left side 118 of housing 102 or by tilting mouse 100I so that portion 198B engages a surface S and then moving mouse 100I across the surface. An encoder (not shown) within housing 102 senses the rotation of wheel 198 and sends signals to a host computer.

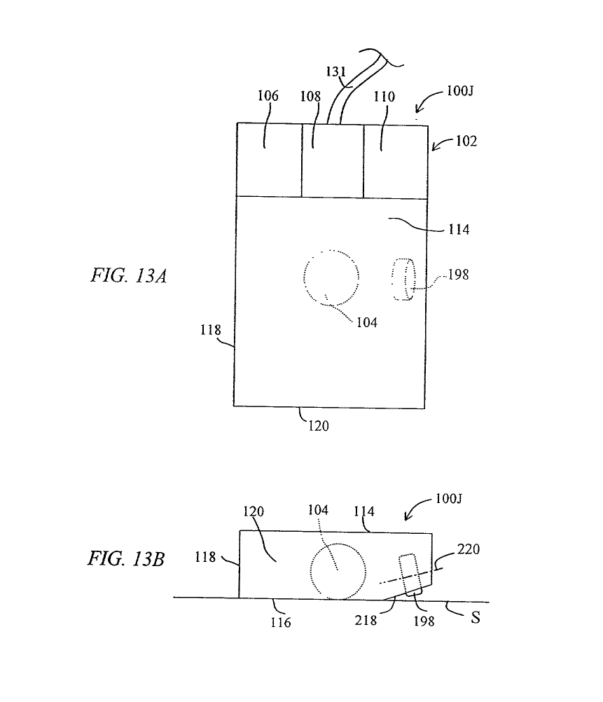

FIGS. 13A and 13B show a mouse 100J wherein a wheel 198 rotatably mounted within housing 102. A portion 198A of wheel 198 protrudes from an aperture on a right bevelled surface 218 of housing 102. Wheel 198 is spaced apart from surface S when mouse 100J sits upright on the surface. Wheel 198 can be rotated about an axis 220 by tilting mouse 100J to the right and engaging portion 198A of wheel 198 with surface S and then moving mouse 100J along the surface. An encoder (not shown) senses the rotation of wheel 198 and sends signals to a host computer.

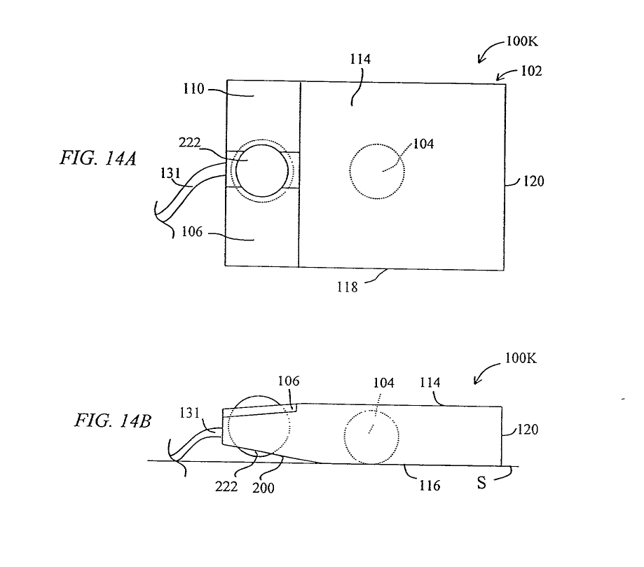

FIGS. 14A and 14B show a mouse 100K which, in addition to a ball 104 has a second ball 222 rotatably mounted to housing 102. A portion 222A of ball 222 protrudes downwardly past a front bevelled surface 200 of housing 102. A portion 222B of ball 222 also protrudes from an aperture between left button 106 and right button 110 on top side 114 of housing 102. Ball 222 is spaced apart from flat surface S when mouse 100K sits upright on the surface.

A user can rotate ball 222 by manipulating exposed portion 222B with his or her finger. The user can also rotate ball 222 by tilting mouse 100K to the front until portion 222A frictionally engages an underlying surface S and then moving mouse 100K across the surface. Two orthogonal encoders (not shown), which may be similar to encoders 146 and 148 for ball 104 (see FIG. 3), sense the rotation of ball 222 and send signals to a host computer.

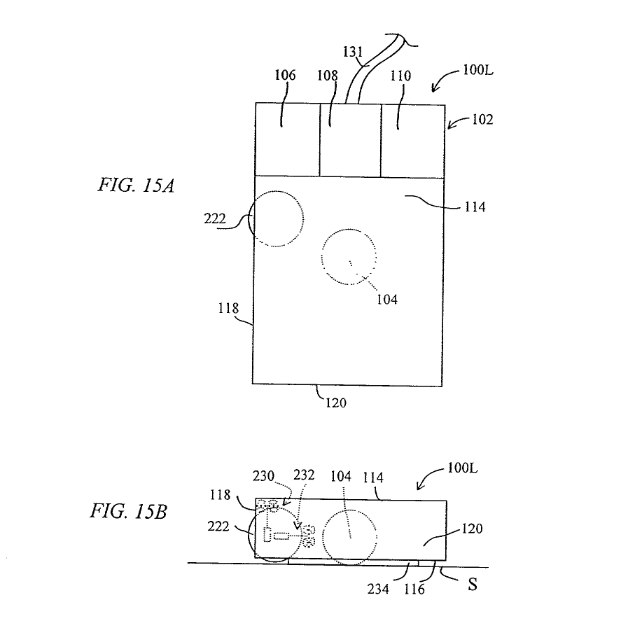

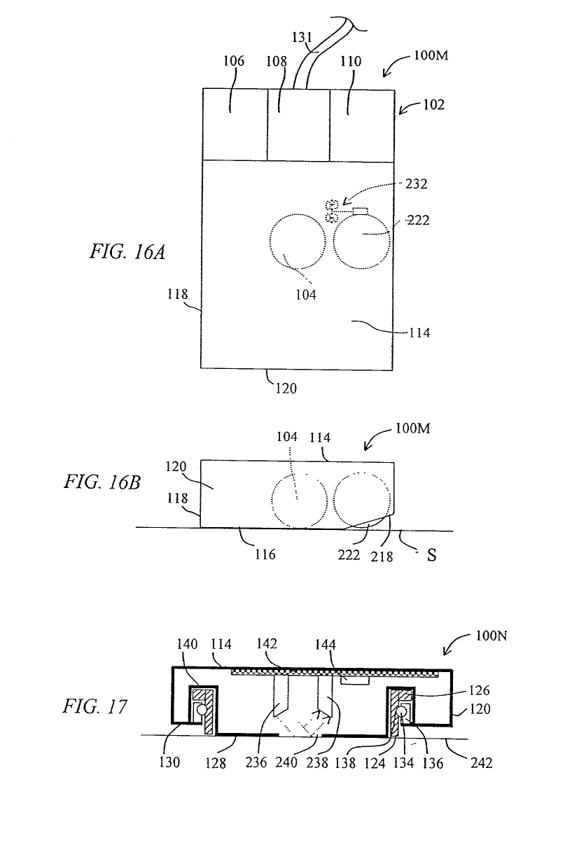

FIGS. 15A through 16B show embodiments which are similar to the embodiment of FIGS. 14A and 14B except that the second ball is in different locations in housing 102. FIGS. 15A and 15B show a mouse 100L which has a second ball 222 having a portion 222B which protrudes from an aperture on left side 118 of housing 102. A portion 222A of ball 222 also protrudes downwardly from bottom side 116 of housing 102. A user can rotate ball 222 about a vertical axis by moving his or her thumb along side 118 while engaging exposed portion 222B. An encoder 230 within housing 102 senses the rotation of ball 222 about the vertical axis and sends signals to a host computer. The user can also rotate ball 222 about a horizontal axis by tilting housing 102 to bring the second ball 222 into contact with an underlying surface S and sliding mouse 100L along surface S. An encoder 232 senses the rotation of ball 222 about an horizontal axis and sends signals to the host computer.

Mouse 100L may also have another encoder situated to sense to sense the rotation of ball 222 about a second horizontal axis orthogonal to that of encoder 232. Mouse 100L is preferably supported by a foot 234 so that ball 222 is spaced apart from flat surface S when mouse 100L sits upright on the flat surface. Ball 222 can be brought to contact with the flat surface by tilting mouse 100L to the left. In the alternative, balls 104 and 222 may both be in contact with surface S when mouse 100L is sitting upright.

FIGS. 16A and 16B show a mouse 100M according to a n embodiment which has a ball 222 rotatably mounted within housing 102. A portion 222A of ball 222 protrudes on a right bevelled surface 218 of housing 102. Ball 222 is spaced apart from flat surface S when mouse 100M sits upright on the surface. A user can cause ball 222 to rotate by tilting mouse 100M to the right until portion 222A frictionally engages surface S and then moving mouse 100M along surface S. An encoder 232 senses the rotation of ball 222 about a horizontal axis and sends signals to a host computer. Optionally another encoder may be orthogonally arranged together with encoder 232, to sense the rotation of ball 222 in two directions.

While ball 104 performs the function of a 2-D position sensor in the embodiments described above, other types of 2D position sensor could also be used in input devices according to this invention. For example, an optical 2-D position sensor could also be used. FIG. 17 shows an embodiment of the invention wherein ball 104 is replaced by an optical sensor. Optical mouse 100N includes a light source 236 and a light sensor 238 mounted to housing 102. Light from light source 236 is projected on an imaged surface 242 through an aperture or window 240. An image of surface 242 is detected by sensor 238. Light sensor 238 senses the motion between mouse 100N and surface 142 and sends signals to a host computer. Optical mice are known to those skilled in the art and can be purchased commercially. The Microsoft ™lntellimouse™ with Intellieye™ is an example of such a mouse. Optical sensors, or other suitable 2-D position sensors which may use radio frequency, magnets, infrared an/or ultrasonic signals. could be used in place of ball 104 and its associated encoders in any of the embodiments described herein.

The specific embodiments of the present invention have been described for purpose of illustration only. As will be apparent to those skilled in the art in the light of the foregoing disclosure, many alterations and modifications are possible in the practice of this invention without departing from the spirit or scope thereof. For example, the mouse according to the present invention can be cordless. The embodiments of the present invention illustrated above are for right-handed use. The embodiments can be readily modified to accommodate the left hand. The rings in mice 100, 100A to 100E and 100N could be exposed on both left and right sides of the housing so as to accommodate both left and right handed users. The ring, roller, drum, wheel or ball can be rotatably mounted within the housing in any suitable manner. The encoder for the ring, roller, wheel or ball can also constructed differently. For example, a circle of holes can be formed on the ring and a light source and light sensor can be placed at each side of the holes to detect the rotation of the ring. The embodiments described above have various combinations of features. Those skilled in the art will realize that the features disclosed in this application can be used in combinations other than those specifically disclosed herein. For example, the springloaded ring of FIGS. 6A and 6B could be used in the mouse of FIGS. 4A and 4B. Other types of rotatable 1-D sensors could be resiliently mounted. The spatial layout of the components of the embodiments described herein and the shaping of housing 102 may all be modified in ways which are consistent with the claims. Many other variations are possible. Accordingly, the scope of the invention is to be construed in accordance with the substance defined by the following claims.

I claim:

1. A computer input device comprising:
a) a hand-holdable housing;
b) a 2-D position sensor on the housing for monitoring movements of the housing relative to a surface under the housing; and,
c) a 1-D position sensor on the housing for monitoring movements of the housing relative to the surface under the housing; wherein, when the housing is on the surface in a first orientation, the 2-D position sensor generates signals responsive to movements of the housing relative to the surface and the 1-D position sensor is insensitive to movements of the housing relative to the surface and, when the housing is on the surface in a second orientation, the 1-D position sensor generates signals responsive to movements of the housing relative to the surface.

2. The input device of claim 1 wherein a lower surface of the housing comprises a portion which projects past the 1-D position sensor and supports the 1-D position sensor spaced apart from the surface when the housing is in its first orientation.

3. The input device of claim 1 wherein the 1-D position sensor comprises a rotatable member rotatably mounted on the housing.

4. The input device of claim 3 wherein a side portion of the rotatable member is exposed on a side of the housing to permit a user to manipulate the exposed portion with a finger.

5. The input device of claim 4 wherein the rotatable member comprises a ring.

6. The input device of claim 5 wherein the ring surrounds the 2-D position sensor.

7. The input device of claim 6 wherein the 2-D position sensor comprises a rotatable ball.

8. The input device of claim 7 wherein the ring and rotatable ball are concentric.

9. The input device of claim 3 wherein the rotatable member is elastically mounted to the housing.

10. The input device of claim 1 wherein the 1-D position sensor comprises a rotatable wheel, the rotatable wheel having a lower surface-contacting portion exposed on a lower face of the housing wherein, when the input device is in its first orientation the rotatable wheel is supported above the surface and in its second orientation the input device is tilted so that the lower surface contacting portion is in frictional engagement with the surface.

11. The input device of claim 10 wherein the rotatable wheel has an upper exposed portion on an upper surface of the housing whereby the rotatable wheel can be turned by manipulating the upper exposed portion with a finger.

12. The input device of claim 10 wherein the rotatable wheel rotates about an axis inclined to the horizontal and the rotatable wheel has an upper portion exposed on a side of the housing whereby the rotatable wheel can be turned around its axis by manipulating the upper exposed portion.

13. The input device of claim 6 wherein the ring has a lower surface-contacting portion which has an adjustable vertical position.

14. The input device of claim 13 wherein the surface contacting portion is threadedly engaged with a main body of the ring.

15. The input device of claim 1 wherein, in the second position the 2-D position sensor is insensitive to movements of the housing relative to the surface and, when the housing is in a third orientation intermediate between the first and second orientations both the 1-D position sensor and the 2-D position sensor are active to generate signals which vary as the housing is moved relative to an underlying surface.

16. The input device of claim 1 wherein the 2-D sensor comprises an optical sensor.

17. A computer input device comprising:
a) a hand holdable housing;
b) a 2-D position sensor on the housing for monitoring movements of the housing relative to a surface under the housing; and,
c) a 1-D control on the housing, the 1-D control comprising a member rotatable about a single axis and an encoder associated with the rotatable member, the encoder generating a signal indicating rotation of the rotatable member about the single axis, the rotatable member frictionally engageable with a surface underlying the housing and rotatable by moving the housing relative to an underlying surface when the rotatable member is frictionally engaged with the underlying surface.

18. The input device of claim 17 wherein the rotatable member comprises a wheel.

19. The input device of claim 18 wherein, when the wheel is sitting upright on a flat surface, the wheel is rotatable about an axis which is generally parallel to the surface.

20. The input device of claim 17 wherein the rotatable member comprises a ring.

21. The input device of claim 20 wherein when the housing is sitting upright on a flat surface the single axis is generally perpendicular to the flat surface.

22. The input device of claim 17 wherein the rotatable member is elastically coupled to the housing.

23. A computer input device comprising:
a) a hand-holdable housing;
b) a 2-D position sensor on the housing for monitoring movements of the housing relative to a surface under the housing; and,
c) a 1-D control on the housing, the 1-D control comprising a rotatable member, the rotatable member having a first exposed portion manipulable by a user's finger or thumb and a second exposed portion on an underside of the housing, the second exposed portion frictionally engageable with a surface under the housing and rotatable by moving the housing across an underlying surface when the rotatable member is frictionally engaged with the underlying surface.

24. The input device of claim 23 wherein the rotatable member comprises a ball.

25. The input device of claim 23 wherein the rotatable member comprises a wheel.

26. The rotatable member of claim 23 wherein the rotatable member comprises a ring.

27. The rotatable member of claim 23 wherein the rotatable member comprises a drum.

28. A computer input device comprising:
a) a hand-holdable housing having a lower surface, the housing configured to sit upright on a surface under the housing;
b) a member rotatably mounted to the housing for rotation about an axis of rotation, the rotatable member having a surface-contacting portion exposed on the lower surface of the housing, the surface-contacting portion lying in a plane generally perpendicular to the axis, the surface contacting portion oriented in the housing such that, when the housing is sitting upright on a surface, the plane of the surface-contacting portion is parallel to the surface, the rotatable member located so as to be rotatable about the axis by frictional contact between the surface-contacting portion and a surface under the housing;
c) an encoder in the housing for sensing rotary motion about the axis of the rotatable member relative to the housing; and,
d) means for transferring rotation information from the encoder to a host computer system.

29. The computer input device of claim 28 wherein the member comprises a circular rim and, when the housing is sitting upright on a flat surface, the circular rim is spaced apart from the surface wherein the circular rim can be brought into frictional engagement with the surface by tilting the housing relative to the surface.
